(19) United States
(12) Patent Application Publication
(10) Pub. No.: US 2015/0242760 A1
(43) Pub. Date: Aug. 27, 2015

(54) Personalized Machine Learning System

(71) Applicant: Microsoft Corporation, Redmond, WA (US)

(72) Inventors: Xu Miao, Seattle, WA (US); Chun-Te Chu, Bellevue, WA (US)

(73) Assignee: Microsoft Corporation, Redmond, WA (US)

(21) Appl. No.: 14/187,132

(22) Filed: Feb. 21, 2014

(51) Int. Cl. G06N 99/00; H04L 29/06

(52) U.S. Cl. CPC G06N 99/005; H04L 67/42

(57) ABSTRACT

Machine learning may be personalized to individual users of computing devices, and can be used to increase machine learning prediction accuracy and speed, and/or reduce memory footprint. Personalizing machine learning can include hosting, by a computing device, a consensus machine learning model and collecting information, locally by the computing device, associated with an application executed by the client device. Personalizing machine learning can also include modifying the consensus machine learning model accessible by the application based, at least in part, on the information collected locally by the client device. Modifying the consensus machine learning model can generate a personalized machine learning model. Personalizing machine learning can also include transmitting the personalized machine learning model to a server that updates the consensus machine learning model.

### BACKGROUND

Machine learning involves various algorithms that can automatically learn from experience. The foundation of these algorithms is built on mathematics and statistics that can be employed to predict events, classify entities, diagnose problems, and model function approximations, just to name a few examples. While there are various products available for incorporating machine learning into computerized systems, those products currently do not provide a good approach to personalizing general purpose machine learning models without compromising personal or private information of users. For example, machine learning models may be configured for general use and not for individual users. Such models may use de-identified data for training purposes, but do not take into account personal or private information of individual users.

In general, machine learning may involve a centralized machine learning approach that provides for all users a single model that is optimized to a “best” average accuracy over the population of all the users. Often the model is a compromise among users because the ideal model cannot exist for everyone at the same time. This centralized machine learning approach also faces challenges in using private data from individual computer devices, which are becoming increasingly popular. Such challenges pose roadblocks to improving user experiences, such as improving voice/vision recognition, personalized searches, and ads targeting, just to name a few examples.

### SUMMARY

This disclosure describes, in part, techniques and architectures for personalizing machine learning to individual users of computing devices without compromising privacy or personal information of the individual users. The techniques described herein can be used to increase machine learning prediction accuracy and speed, and reduce memory footprint, among other benefits. Personalizing machine learning may be performed locally at a computing device, and may include interaction with a server on a network shared with a plurality of other computing devices. For example, a personalized machine learning approach may use a distributed asynchronous optimization algorithm to deliver personalized machine learning models that fit well with substantially all personal devices on a shared network. Such personalized machine learning models can be optimized for maximizing individual model accuracy while contributing to maximizing population model accuracy. Moreover, personal data need not leave each computing device, yet the personal data can contribute to improving a global model that iteratively improves personal models of each computing device.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), and/or other technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented, according to various example embodiments.

FIG. 2 is a block diagram of a machine learning system, according to various example embodiments.

FIG. 3 is a block diagram of an iterative machine learning model process, according to various example embodiments.

FIG. 4 is a flow diagram of a process for personalizing a machine learning model based, at least in part, on information collected locally by a plurality of client devices, according to various example embodiments.

FIG. 5 is a block diagram of an iterative process of personalizing a machine learning model, according to various example embodiments.

FIG. 6 is a schematic diagram of feature measurements for three users of client devices, according to some embodiments.

FIG. 7 shows feature distributions and an aggregated feature distribution, according to various example embodiments.

FIG. 8 shows normalized distributions of a feature, according to various example embodiments.

### DETAILED DESCRIPTION

### Overview

In various embodiments, techniques and architectures are used to personalize machine learning to individual users of computing devices. For example, such computing devices, hereinafter called client devices, may include desktop computers, laptop computers, tablet computers, telecommunication devices, personal digital assistants (PDAs), electronic book readers, wearable computers, automotive devices, gaming devices, and so on. A client device capable of personalizing machine learning to individual users of the client device can increase accuracy and speed of machine learning prediction. Among other benefits, personalized machine learning can involve a smaller memory footprint and a smaller CPU footprint compared to the case of non-personalized machine learning. In some implementations, a user of a client device has to “opt-in” or take other affirmative action before personalized machine learning can occur.

In some embodiments, techniques and architectures for personalizing machine learning to individual users of computing devices involve a network server that is shared among the computing devices. For example, personalizing machine learning may be performed locally at a computing device, and may include interaction with a server on a network shared with a plurality of other computing devices. A personalized machine learning approach may use a distributed asynchronous optimization algorithm to deliver personalized machine learning models that fit at least fairly well with substantially all computing devices on a shared network. Such personalized machine learning models can be optimized for maximizing individual model accuracy (e.g., at each of the computing devices) while contributing to maximizing population model accuracy (e.g., at the server). Moreover, to maintain privacy, for example, personal data need not leave each computing device, yet the personal data can contribute to improving a global model that iteratively improves personal models of each computing device.

In some embodiments, an iterative process that continuously improves upon a machine learning model includes communication between the server and the individual computing devices. For example, data gathered locally by each of the computing devices can be used to personalize machine learning models on each of the respective computing devices. The personalized machine learning models of each of the respective computing devices can be transmitted from each of the computing devices to a server, which can subsequently aggregate this plurality of personalized machine learning models. A process of aggregation can be performed by the server using any of a number of techniques, such as normalization, some of which are described below.

Subsequent to such aggregation, the server can update a global machine learning model based, at least in part, on the plurality of personalized machine learning models from the respective computing devices. The server can then transmit the updated global machine learning model to each of the respective computing devices, each of which can subsequently aggregate this updated global machine learning model with the personalized machine learning model already on the respective computing device. A process of aggregation can be performed by each of the computing devices using any of a number of techniques, some of which are described below.

Subsequent to such aggregation, each of the computing devices can update their respective personalized machine learning model based, at least in part, on the global machine learning model received from the server. Moreover, data gathered locally by each of the computing devices can be used to further personalize the updated machine learning models on each of the respective computing devices. The updated personalized machine learning models of each of the respective computing devices can then be transmitted from each of the computing devices to the server. This process of updating and communicating (e.g., transmitting and receiving) between a plurality of computing devices and the server repeats and, in doing so, iteratively improves upon the global machine learning model maintained by the server and each of the personalized machine learning models of the respective computing devices.

In various embodiments, processes of personalizing and/or improving machine learning models can be performed without compromising privacy or personal information of the individual users of the computing devices. The techniques described herein can be used to increase machine learning prediction accuracy and speed, and reduce memory footprint for the computing devices, among other benefits. Hereinafter, computing devices are called “client devices”.

Personalizing machine learning can be implemented in a number of ways. For example, in some implementations, personalizing machine learning for a client device can involve adjusting a classification boundary (e.g., a threshold) of the machine learning model based, at least in part, on information collected locally by the client device. A process of adjusting a classification threshold may be based, at least in part, on information associated with an application executed by a processor of the client device. The information, collected by the client device can include: an image, a voice or other audio sample, or a search query, among other examples. The information can include personal information of a user of the client device, such as a physical feature (e.g., mouth size, eye size, voice volume, tones, and so on) gleaned from captured images or voice samples, for example. A particular physical feature of one user is generally different from the particular physical feature of another user. For example, different classification threshold values can be assigned to different ethnic groups: Users having Asian descent, for example, statistically have physical features (e.g., eye size and body height) that are different from users having Caucasian descent. Therefore a different threshold value t may be appropriate for different ethnic groups.

A physical feature for each user can be represented as a distribution of values (e.g., number of occurrences as a function of mouth size over time). Maxima and minima (e.g., peaks and valleys) of the distribution can be used to indicate a number of things, such as various states of a feature of a user. For example, a local minimum between two local maxima in a distribution of a user's mouth size can be used to define a classification boundary between the user's mouth being open or the user's mouth being closed. In general, such distributions of values for different users will be different. In particular, positions and magnitudes of peaks and valleys of the distributions are different for different users. Accordingly, and undesirably, aggregating distributions of a number of users tends to un-resolve peaks and valleys of the distributions of the individual users. In other words, combining distributions of a number of users leads to an aggregated distribution that blurs out peaks and valleys of the distributions of the individual users. Such results from combining distributions can occur for machine learning models that are based on de-identified data of multiple users.

In some embodiments, distributions of features of a number of users of client devices can be aggregated by a process of normalizing distributions of the individual users based on information collected locally by the individual client devices. Such a process, which can be performed by a server and/or by the individual client devices, can lead to an aggregated distribution that can be resolved. Such a resolved aggregated distribution can have a clearly definable (e.g. non-ambiguous) classification boundary, which can be incorporated into an updated (e.g., further personalized) machine learning model.

In one example implementation of personalizing a machine learning model, a processor of a server can normalize a feature output of a global machine learning model by aligning a classification boundary (e.g., a classification threshold) of the feature output with classification boundaries of corresponding feature outputs based, at least in part, on personalized machine learning models hosted by other client devices that provided the personalized machine learning models to the server.

In some implementations, a feature output of a global machine learning model on a server can be updated, or further refined, by using de-identified data from a plurality of client devices that are members of a network that includes the server. For example, normalizing the feature output of the global machine learning model generates a normalized output that can be aggregated with the de-identified data received from the client devices. De-identified data includes data that has been stripped of information (e.g., metadata) regarding an association between the data and a person (e.g., user of a client device) to whom the data is related.

In some embodiments, methods described above may be performed in whole or in part by a server or other computing device in a network (e.g., the Internet or the cloud). For example, a server can update and improve a global machine learning model by normalizing and aligning feature distributions of multiple client devices. The server may, for example, receive, from a first client device, a first feature distribution generated by a first machine learning model hosted by the first client device, and receive, from a second client device, a second feature distribution generated by a second machine learning model hosted by the second client device. The server may subsequently normalize the first feature distribution with respect to the second feature distribution so that classification boundaries for each of the first feature distribution and the second feature distribution align with one another. The server may then provide to the first client device a normalized first feature distribution resulting from normalizing the first feature distribution with respect to the second feature distribution. The first feature distribution may be based, at least in part, on information collected locally by the first client device. The method can further comprise normalizing the first feature distribution with respect to a training distribution so that the classification boundaries for each of the first feature distribution and the training distribution align with one another.

As mentioned above, a client device can update and improve a personalized machine learning model on the client device by adjusting a classification threshold value of the personalized machine learning model based, at least in part, on information collected locally by the client device. The information may be associated with an application executed by a processor of the client device. Such information may be considered private information of a user of the client device. A user intends to have their private information remain on the client device. For example, private information may include images and/or videos captured and/or downloaded by a user of the system, images and/or videos of the user, a voice sample of the user of the system, or a search query from the user of the system. In some implementations, a user of a client device has to “opt-in” or take other affirmative action to allow the client device or system to adjust a classification threshold value of a machine learning model.

In some implementations, individual real-time actions of a user of a client device need not influence personalized machine learning, while long-term behaviors of the user show patterns that can be used to personalize machine learning. For example, the feature output of the machine learning model can be responsive to a pattern of behavior of a user of the client device over at least a predetermined time, such as hours, days, months, and so on.

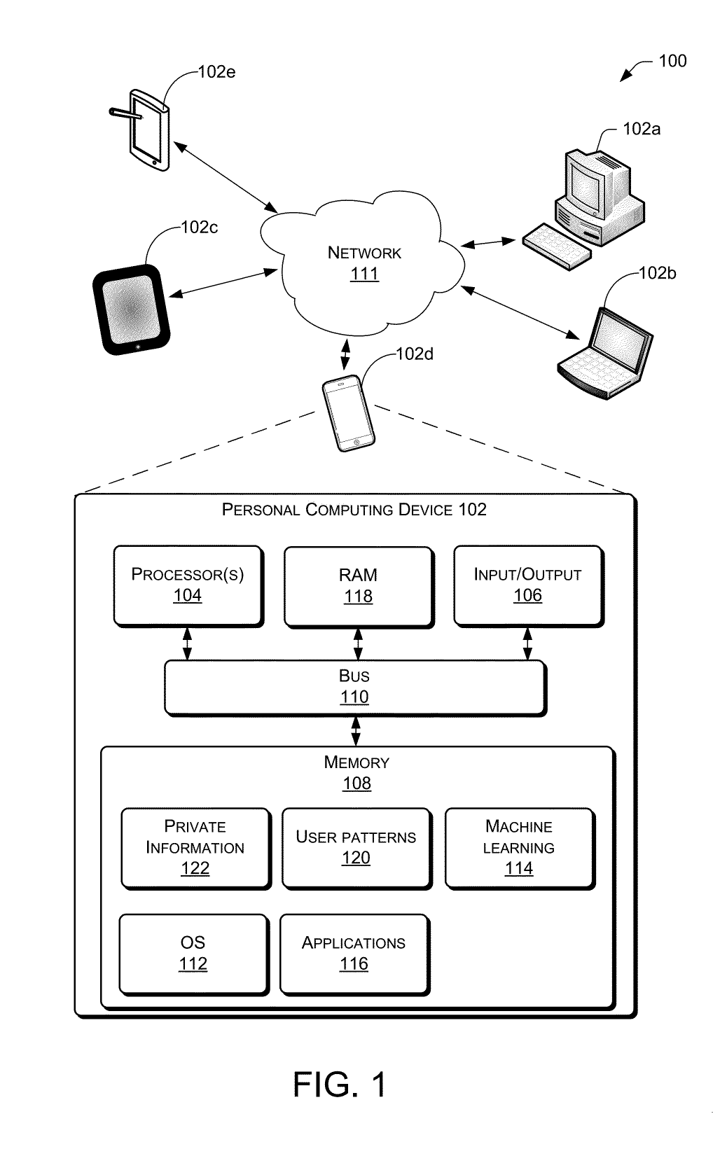

Various embodiments are described further with reference to FIGS. 1-8.

### Example Environment

The environment described below constitutes but one example and is not intended to limit the claims to any one particular operating environment. Other environments may be used without departing from the spirit and scope of the claimed subject matter. FIG. 1 shows an example environment 100 in which embodiments involving personalizing machine learning as described herein can operate. In some embodiments, the various devices and/or components of environment 100 include a variety of computing devices 102. In various embodiments, computing devices 102 may include devices 102a-102e. Although illustrated as a diverse variety of device types, computing devices 102 can be other device types and are not limited to the illustrated device types. Computing devices 102 can comprise any type of device with one or multiple processors 104 operably connected to an input/output interface 106 and memory 108, e.g., via a bus 110. Computing devices 102 can include, for example, desktop computers 102a, laptop computers 102b, tablet computers 102c, telecommunication devices 102d, personal digital assistants (PDAs) 102e, electronic book readers, wearable computers, automotive computers, gaming devices, etc. Computing devices 102 can also include business or retail oriented devices such as, for example, server computers, thin clients, terminals, and/or work stations. In some embodiments, computing devices 102 can include, for example, components for integration in a computing device, appliances, or another sort of device. In some embodiments, some or all of the functionality described as being performed by computing devices 102 may be implemented by one or more remote peer computing devices, a remote server or servers, or a cloud computing resource. For example, computing devices 102 can execute applications that are stored remotely from the computing devices.

In some embodiments, as shown regarding device 102d, memory 108 can store instructions executable by the processor(s) 104 including an operating system (OS) 112, a machine learning module 114, and programs or applications 116 that are loadable and executable by processor(s) 104. The one or more processors 104 may include one or more central processing units (CPUs), graphics processing units (GPUs), video buffer processors, and so on. In some implementations, machine learning module 114 comprises executable code stored in memory 108 and is executable by processor(s) 104 to collect information, locally by computing device 102, via input/output 106. The information is associated with applications 116.

For example, machine learning module 114 can modify a machine learning model accessible by any of applications 116 based, at least in part, on information collected locally by the client device. Modifying the machine learning model generates a personalized machine learning model, which can be transmitted (e.g., via input/output interface 106) to a server. Subsequently, computing device 102 may receive a global machine learning model from the server. The global machine learning model may be based, at least in part, on the personalized machine learning model transmitted to the server and an aggregation, performed by the server, of a plurality of other personalized machine learning models transmitted from a plurality of other client devices to the server.

Machine learning module 114 may access user patterns module 120 and private information module 122. For example, patterns module 120 may store user profiles that include history of actions by a user, applications executed over a period of time, and so on. Private information module 122 stores information collected or generated locally by computing device 102. Such private information may relate to the user or the user's actions. Such information can be accessed by machine learning module 114 to adjust a classification threshold value for the user, for example, to improve personalization of a machine learning model of computing device 102. Private information need not be shared or transmitted beyond computing device 102. Further, in some implementations, a user of computing device 102 has to “opt-in” or take other affirmative action to allow computing device 102 to store private information in private information module 122.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some embodiments, computing device 102 can be associated with a camera capable of capturing images and/or video and/or a microphone capable of capturing audio. For example, input/output module 106 can incorporate such a camera and/or microphone. Memory 108 may include one or a combination of computer readable media.

Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media. In various embodiments, memory 108 is an example of computer storage media storing computer-executable instructions. When executed by processor(s) 104, the computer-executable instructions can configure the processor(s) to, among other things, execute an application and collect information associated with the application. The information may be collected locally by computing device 102. When executed, the computer-executable instructions can also configure the processor(s) to normalize a feature output of a machine learning model accessible by the application based, at least in part, on the information collected locally by the client device.

In various embodiments, an input device of input/output (I/O) interfaces 106 can be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106 to allow the computing device 102 to communicate with other devices. Input/output (I/O) interfaces 106 can include one or more network interfaces to enable communications between computing device 102 and other networked devices such as other device(s) 102. Input/output (I/O) interfaces 106 can allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

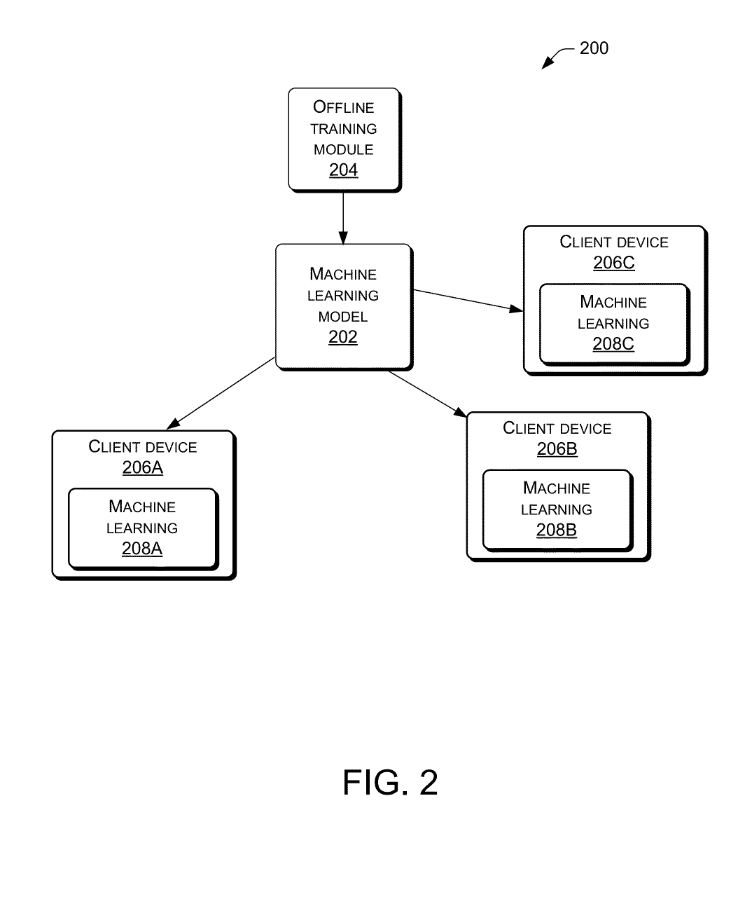

FIG. 2 is a block diagram of a machine learning system 200, according to various example embodiments. Machine learning system 200 includes machine learning model 202, offline training module 204, and a number of client devices 206A-C. Machine learning model 202 can be used by each of a plurality of client devices and/or a server as an initial machine learning model. For example, machine learning model 202 may be loaded onto a server as an initial global machine learning model that can subsequently be updated based, at least in part, on de-identified data collected on one or more client devices. In another example, machine learning model 202 may be loaded onto a client device as an initial machine learning model that can subsequently be personalized to a user of the client device.

Machine learning model 202 can receive training data from offline training module 204. For example, training data can include data from a population, such as a population of users operating client devices or applications executed by a processor of client devices. Data can include information resulting from actions of users or can include information regarding the users themselves. For example, mouth sizes of each of a number of users can be measured while the users are engaged in a particular activity. Such measurements can be gleaned, for example, from images of the users captured at various or periodic times. Mouth size of a user can indicate a state of a user, such as the user's level of engagement with the particular activity, emotional state, or physical size, just to name a few examples. Data from the population can be used to train machine learning model 202. Subsequent to such training, machine learning model 202 can be implemented in client devices 206A-C. Thus, for example, training using the data from the population of users for offline training can act as initial conditions for a global machine learning model (e.g., on a server) or a personalized machine learning model (e.g., on a client device).

Machine learning model 202, in part as a result of offline training module 204, can be configured for a relatively large population of users. For example, machine learning model 202 can include a number of classification threshold values that are set based on average characteristics of the population of users of offline training module 204. Client devices 206A-C can modify machine learning model 202, however, subsequent to machine learning model 202 being loaded onto client devices 206A-C. In this way, customized/personalized machine learning can occur on individual client devices 206A-C. The modified machine learning model is designated as machine learning 208A-C. In some implementations, for example, machine learning 208A comprises a portion of an operating system of client device 206A. Modifying machine learning on a client device is a form of local training of a machine learning model. Such training can utilize personal information already present on the client device, as explained below. Moreover, users of client devices can be confident that their personal information remains private while the client devices remain in their possession.

In some embodiments, characteristics of machine learning 208A-C change in accordance with particular users of client devices 206A-C. For example, machine learning 208A hosted by client device 206A and operated by a particular user can be different from machine learning 208B hosted by client device 206B and operated by another particular user. Behaviors and/or personal information of a user of a client device are considered for modifying various parameters of machine learning hosted by the client device. Behaviors of the user or personal information collected over a predetermined time can be considered. For example, machine learning 208A can be modified based, at least in part, on historical use patterns, behaviors, and/or personal information of a user of client device 206A over a period of time, such as hours, days, months, and so on. Accordingly, modification of machine learning 208A can continue with time, and become more personal to the particular user of client device 208A. A number of benefits result from machine learning 208A becoming more personal to the particular user. Among such benefits, precision of output of machine learning 208A increases, efficiency (e.g., speed) of operation of machine learning 208A increases, and memory footprint of machine learning 208A decreases, just to name a few example benefits. Additionally or alternatively, users may be allowed to opt out of the use of personal/private information to personalize the machine learning.

Client devices 206A-C can include computing devices that receive, store, and operate on data that a user of the computing device considers private. That is, the user intends to maintain such data within the computing device. Private data can include data files (e.g., text files, video files, image files, and audio files) comprising personal information regarding the user, behaviors of the user, attributes of the user, communications between the user and others, queries submitted by the user, and network sites visited by the user, just to name a few examples.

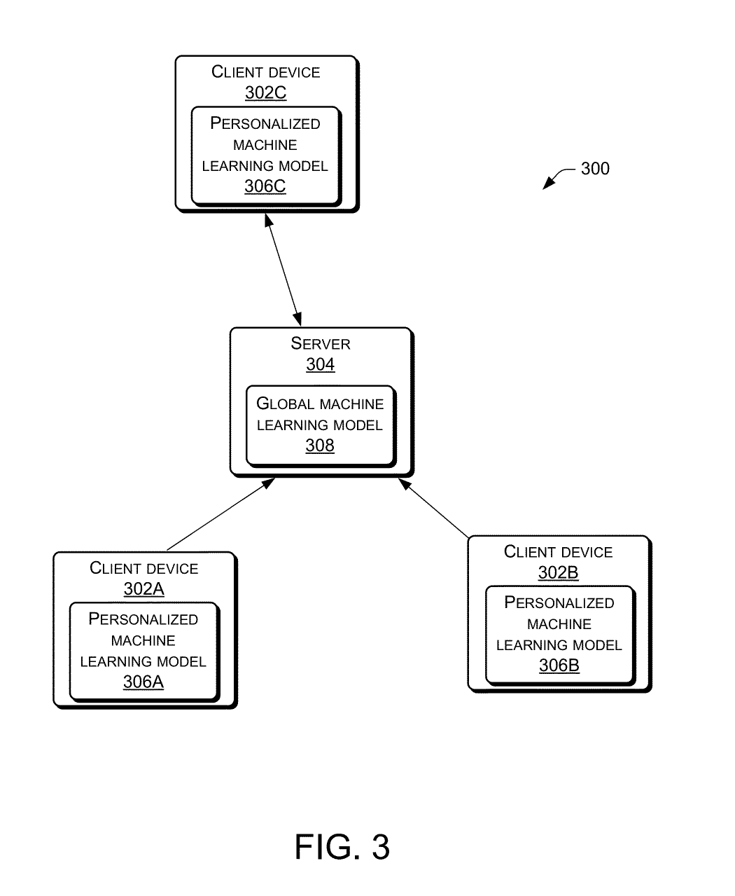

FIG. 3 is a block diagram of an iterative machine learning model process performed on a shared network 300, according to various example embodiments. Personalizing machine learning to individual users of a plurality of client devices 302A-C involves a network server 304 that is shared among the client devices. For example, personalizing a machine learning models 306A may be performed locally at client device 302A, and may include interaction with server 304 on network 300 shared with a plurality of other client devices 302B-C. A personalized machine learning approach may use a distributed asynchronous optimization algorithm, described below, to deliver personalized machine learning models 306A-C that fit well with substantially all client devices 302A-C on shared network 300. Such personalized machine learning models 306A-C can be optimized for maximizing individual model accuracy (e.g., at each of client devices 302A-C) while contributing to maximizing population model accuracy (e.g., at server 304). Moreover, to maintain privacy, for example, personal data need not leave each of client devices 302A-C, yet the personal data can contribute to improving a global machine learning model 308 that iteratively improves personal machine learning models 306A-C of each of client devices 302A-C.

In some embodiments, an iterative process that continuously improves upon a machine learning model includes communication between server 304 and the individual client devices 302A-C. For example, data gathered locally by each of the client devices 302A-C can be used to personalize machine learning models 306A-C on each of the respective client devices 302A-C. The personalized machine learning models 306A-C of each of the respective client devices 302A-C can be transmitted from each of the client devices 302A-C to server 304, which can subsequently aggregate the plurality of personalized machine learning models 306A-C. A process of aggregation can be performed by the server using any of a number of techniques, some of which are described below.

Subsequent to such aggregation, server 304 can update global machine learning model 308 based, at least in part, on the plurality of personalized machine learning models 306A-C from the respective client devices 302A-C. The server can then transmit the updated global machine learning models 306A-C to each of the respective client devices 302A-C, each of which can subsequently aggregate the updated global machine learning model 308 with personalized machine learning models 306A-C already on the respective client devices 302A-C. A process of aggregation can be performed by each of the client devices 302A-C using any of a number of techniques, some of which are described below.

Subsequent to such aggregation, each of the client devices 302A-C can update their respective personalized machine learning model 306A-C based, at least in part, on the updated global machine learning model 308 received from server 304. Moreover, data gathered locally by each of the client devices 302A-C can be used to further personalize the updated machine learning models 306A-C on each of the respective client devices 302A-C. The updated personalized machine learning models 306A-C of each of the respective client devices 302A-C can then be transmitted from each of the client devices 302A-C to server 304. This process of updating and communicating (e.g., transmitting and receiving) between a plurality of client devices 302A-C and server 304 repeats and, in doing so, iteratively improves upon global machine learning model 308 maintained by server 304 and each of the personalized machine learning models 306A-C of the respective client devices 302A-C.

In some embodiments, a distributed asynchronous optimization algorithm used to deliver personalized machine learning models involves an alternating direction method of multipliers (ADMM), which includes a minimization problem, defined in equation 1 below.

minimize{Σᵢ₌₁Σⱼ₌₁[L(x_{i,j},y_{i,j}|ŵ)]+(λ/2)*|z|²+Σᵢ₌₁[I(D(ŵ∥zᵢ)<ε]} eqn. (1)

Equation 1 is subject to the condition that zᵢ=z. The first and third summations in equation 1 are over the index i of individual users of client devices. The second summation in equation 1 is over the index j of samples of an input feature for a machine learning model. For example, for each individual user i there are j input features. L(x_{i,j},y_{i,j}|ŵ) is a loss function, which can be an arbitrary convex function. In one implementation, L(x_{i,j},y_{i,j},|ŵ) is a square hinge loss function, wherein L(x_{i,j},y_{i,j}|ŵ) =max(0,1−y_{i,j}ŵ^{T}x_{i,j})². x_{i,j} is an input feature vector representing information collected locally by individual client devices, y_{i,j} is a target label vector representing target labels of the personalized machine learning model, ŵᵢ is a personalized machine learning model for each user i, ŵ^{T} is the transpose of the vector representing the personalized machine learning model. z is a global machine learning model, and zᵢ is a global machine learning model based, at least in part, on individual users i. D(ŵᵢ∥zᵢ) represents a distance between ŵ, and zᵢ, and ε represents a distance between personalized machine learning models of individual users ŵᵢ and the global machine learning model zᵢ based, at least in part, on individual users i. In the third term of equation 1, I is an “indicator function” that is equal to zero if its condition is true, and is equal to one if its condition is false.

The second term in equation 1, [(λ/2)*|z|²], includes λ, which is an estimate of a Lagrange multiplier. This variable is used in augmented Lagrangian algorithms that are used for solving constrained optimization problems. The accuracy of generally improves with every iteration of ADMM, for example.

In equation 1, personalized machine learning model w is mathematically separable so that individual terms in the model can be optimized in a distributed fashion by individual client devices and a server that communicatively ties together the client devices. For example, each individual personalized machine learning model from each client device can be collected and aggregated together at the server. This collection and aggregation can be used to update a global machine learning model, which can subsequently be transmitted to each individual client device to update the personalized machine learning models. These updated personalized machine learning models can be further updated at each of the individual client devices (e.g., based on information collected at each client device) and, again, the further-updated personalized machine learning models can be collected and aggregate together at the server. After a sufficient number of iterations, using a process involving ADMM, personalization of individual machine learning models for individual client devices will converge to stable and increasingly precise solutions.

In addition to a number of other functions, a machine learning model, such as a personalized machine learning model ŵᵢ for a client device and a global machine learning model z for a server, may classify features into states. For example, mouth size of a user of a client device is a feature that can be classified as being in an open state or a closed state. Moreover, mouth size or state can be used as a parameter on which to determine whether the user is in a happy state or sad state, among a number of other emotional states. Machine learning models include classifiers that make decisions based, at least in part, on comparing a value of a decision function ƒ(x) with a threshold value t. Increasing the threshold value t increases precision of the classification, though recall correspondingly decreases. For example, if a threshold value t for determining if a feature is in a particular state is set relatively high, then there will be relatively few determinations (e.g., recall) that the feature is in the particular state, but the fraction of the determinations being correct (e.g., precision) will be relatively high. On the other hand, decreasing the threshold value t decreases precision of the classification, though recall correspondingly increases. In some embodiments, a distributed asynchronous optimization algorithm involving ADMM, which includes a minimization problem of equation 1, can be used to personalize a machine learning model to a user of a client device by determining threshold values that are a “best-fit” for a number of features for the user.

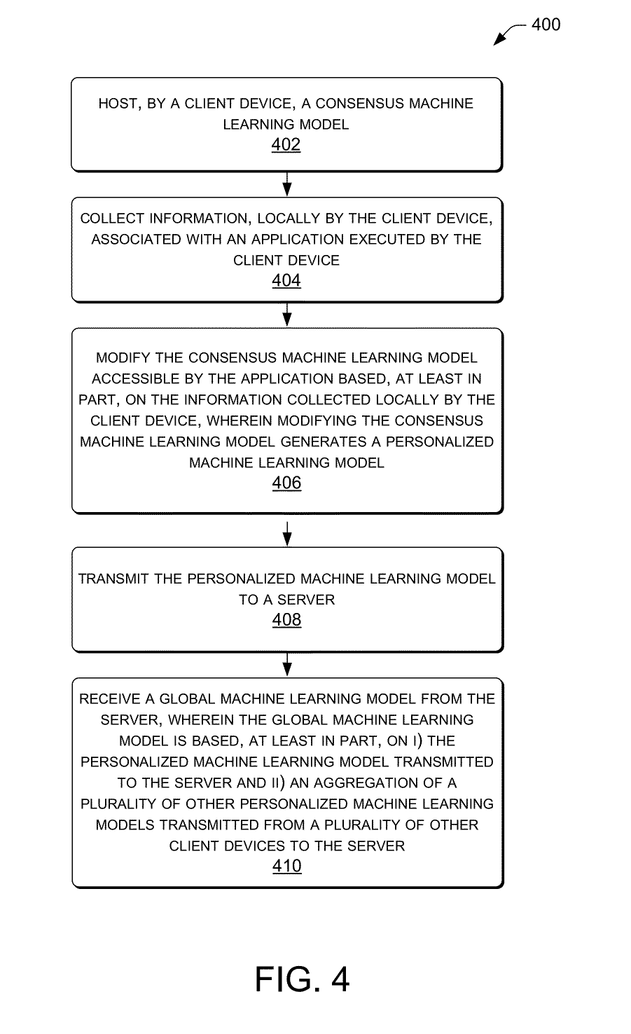

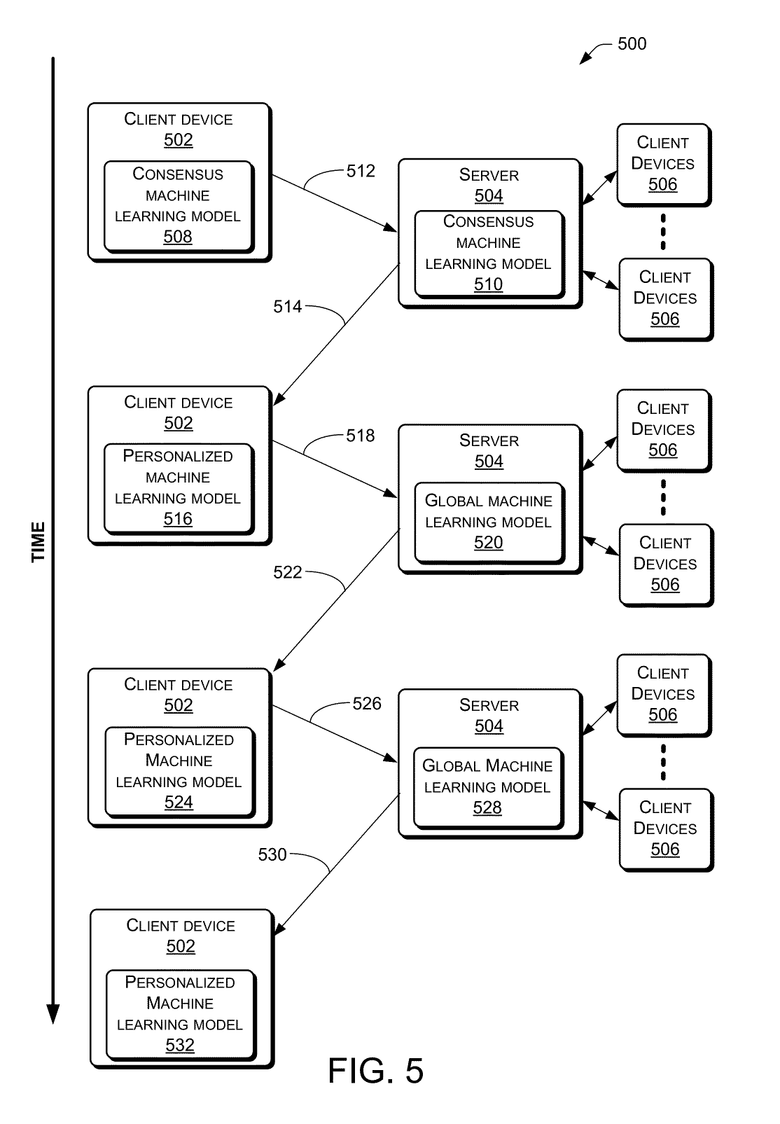

FIG. 4 is a flow diagram of a process 400 for personalizing a machine learning model based, at least in part, on information collected locally by a plurality of client devices, according to various example embodiments. Such a process can be applied to an embodiment 500 of a system that includes a client device 502, a server 504, and a plurality of other client devices 506, as shown in FIG. 5, for example. In particular, FIG. 5 is a block diagram of client device 502, server 504, and client devices 506 arranged to schematically illustrate process 400. FIG. 5 also includes a time line to illustrate a general flow of process 400, which may be performed synchronously or asynchronously, as described below. The time line is not intended to represent a linear and/or continuous flow of time, and claimed subject matter is not so limited.

At block 402, client device 502 hosts a consensus machine learning model 508, which may be stored in memory of client device 502. For example, machine learning module 114 of memory 108, shown in the embodiment of FIG. 1, can store such a consensus machine learning model. In some implementations, a consensus machine learning model can be used by each of client device 502, server 504, and the plurality of other client devices 506 as an initial machine learning model. For example, in addition to consensus machine learning model 508 being initially loaded onto client device 502, a consensus machine learning model 510 may be loaded onto server 504 as an initial global machine learning model that can subsequently be updated based, at least in part, on de-identified data collected on one or more of client devices 506. In another example, as described below, consensus machine learning model 508 may be loaded onto client device 502 as an initial machine learning model that can subsequently be personalized to a user of client device 502. Consensus machine learning model 508 can be based, at least in part, on training data that includes data from a population, such as a population of users operating client devices (e.g., other than client device 502) or applications executed by a processor of client devices. Data can include information resulting from actions of users or can include information regarding the users themselves. Data from the population of users can be used to train consensus machine learning model 508. Thus, for example, training using the data from the population of users for offline training can act as initial conditions for a global machine learning model (e.g., on server 504) or a personalized machine learning model (e.g., on client device 502).

At block 404, client device 502 collects information locally. Such information may be associated with an application executed by client device 502. Information collected locally may include images and/or videos captured and/or downloaded by a user of client device 502, images and/or videos of the user, a voice sample of the user, or a search query from the user, just to name a few examples.

At block 406, client device 502 may modify consensus machine learning model 508 based, at least in part, on the information collected locally by client device 502. Client device 502 (e.g., an individual user) can modify consensus machine learning model 508 by performing an operation (e.g., minimization problem) that includes the first and third terms of equation 1 for an individual user i, which is equation 2:

minimize{Σⱼ₌₁[L(x_{i,j},y_{i,j}|ŵ)]+I(D(ŵᵢ∥zᵢ)<ε)} eqn. (2)

Such modifying generates a personalized machine learning model which, at block 408, is transmitted to server 504, as indicated by arrow 512. Subsequently, server 504 may modify consensus machine learning model 510 based, at least in part, on the personalized machine learning model transmitted to server 504 from client device 502 and an aggregation of a plurality of other personalized machine learning models transmitted from each of the plurality of other client devices 506 to server 504. Server 504 can modify consensus machine learning model 510 by performing an operation (e.g., minimization problem) that includes the second term of equation 1, which is equation 3:

minimize{Σᵢ₌₁[(λ/2)*|z|²]} subject to z=zᵢ for all i eqn. (3)

Modifying consensus machine learning model 510 generates a global machine learning model that is transmitted by server 504 and received, at block 410, by client device 502, as indicated by arrow 514. In addition, server 504 may transmit the global machine learning model to at least a portion of the plurality of client devices 506.

Process 400 can be repeated with consensus machine learning model 508 being replaced with a personalized machine learning model 516, which is based, at least in part, on the global machine learning model received from server 504. Over a period of time, client device 502 modifies personalized machine learning model 516 by performing an operation (e.g., minimization problem) of equation 2. Such modifying generates an updated personalized machine learning model that is further personalized to the user of client device 502. The time period for modifying personalized machine learning model 516 can range from minutes to days or longer. Such a time period can be set by the user, can be predetermined by a default value set during fabrication of client device 502, or can be a value downloaded into client device 502 at some time after its fabrication, for example. In some implementations, the time period need not be synchronous with the other client devices 506. In other words, time periods for modifying respective personalized machine learning models of client devices 502 and 506 can be different from one another.

Using equation 2, client device 502 modifies personalized machine learning model 516 based, at least in part, on information collected locally by client device 502 during the time period. Such information may be associated with an application executed by client device 502. Information collected locally may include images and/or videos captured and/or downloaded by a user of client device 502, images and/or videos of the user, a voice sample of the user, or a search query from the user, just to name a few examples.

After a time span, the updated personalized machine learning model is transmitted to server 504, as indicated by arrow 518. Subsequently, server 504 may modify global machine learning model 520 based, at least in part, on the personalized machine learning model transmitted to server 504 from client device 502 and an aggregation of a plurality of other personalized machine learning models transmitted from each of the plurality of other client devices 506 to server 504. Server 504 can modify global machine learning model 520 by performing an operation (e.g., minimization problem) of equation 3. Modifying global machine learning model 520 generates an updated global machine learning model that is further refined toward an “optimal” solution corresponding to client device 502 and client devices 506. The time period for modifying global machine learning model 520 can range from minutes to days or longer. Such a time period need not be synchronous with any of client device 502 and client devices 506. The updated global machine learning model is subsequently transmitted by server 504 to client device 502, as indicated by arrow 522. In addition, server 504 may transmit the updated global machine learning model to at least a portion of the plurality of client devices 506.

Continuing iterative process 400, client device 502 includes a personalized machine learning model 524 that is based, at least in part, on the global machine learning model received from server 504. Over a period of time, client device 502 modifies personalized machine learning model 524 by performing an operation (e.g., minimization problem) of equation 2. Such modifying generates an updated personalized machine learning model that is further personalized to the user of client device 502. The time period for modifying personalized machine learning model 524 can range from minutes to days or longer, and can be different from earlier time periods used by client device 502, for example.

Using equation 2, client device 502 modifies personalized machine learning model 524 based, at least in part, on information collected locally by client device 502 during the time period. Such information may be associated with an application executed by client device 502.

After the time span, the updated personalized machine learning model is transmitted to server 504, as indicated by arrow 526. Subsequently, server 504 may modify global machine learning model 528 based, at least in part, on the personalized machine learning model transmitted to server 504 from client device 502 and an aggregation of a plurality of other personalized machine learning models transmitted from each of the plurality of other client devices 506 to server 504. Server 504 can modify global machine learning model 520 by performing an operation (e.g., minimization problem) of equation 3. Modifying global machine learning model 528 generates an updated global machine learning model that is further refined toward an “optimal” solution corresponding to client device 502 and client devices 506. The time period for modifying global machine learning model 528 can range from minutes to days or longer. Such a time period need not be synchronous with any of client device 502 and client devices 506. The updated global machine learning model is subsequently transmitted by server 504 to client device 502, as indicated by arrow 530. In addition, server 504 may transmit the updated global machine learning model to at least a portion of the plurality of client devices 506.

Continuing iterative process 400, client device 502 includes a personalized machine learning model 532 that is based, at least in part, on the global machine learning model received from server 504. Over a period of time, client device 502 modifies personalized machine learning model 532 by performing an operation (e.g., minimization problem) of equation 2. Such modifying generates an updated personalized machine learning model that is further personalized to the user of client device 502. The time period for modifying personalized machine learning model 532 can range from minutes to days or longer, and can be different from earlier time periods used by client device 502, for example.

Using equation 2, client device 502 modifies personalized machine learning model 532 based, at least in part, on information collected locally by client device 502 during the time period. Such information may be associated with an application executed by client device 502. After the time span, the updated personalized machine learning model is transmitted to server 504. Process 400 can continue in an iterative fashion, as described above.

### Personalization by Classification Threshold Adjustment

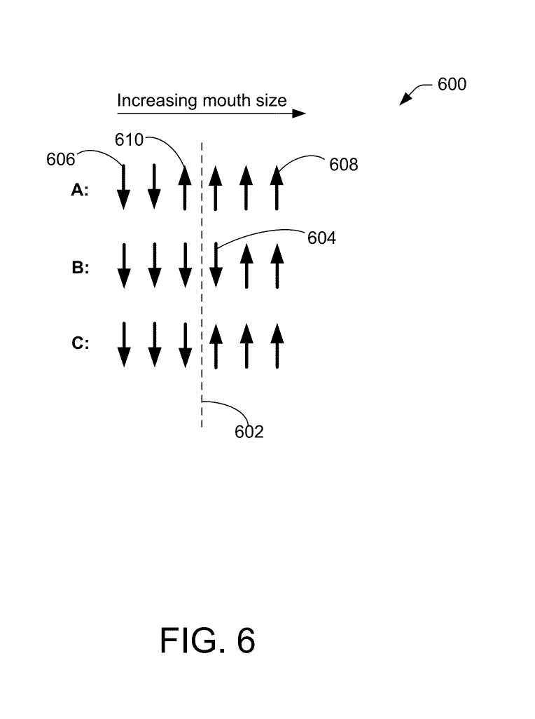

FIG. 6 is a schematic diagram of feature measurements 600 for three users A, B, and C of client devices. In some implementations the client devices can be the same for two or more of the users. For example, two or more users may share a single client device. In other implementations, however, client devices are different for each user. Feature measurements 600 are displayed with respect to a classification threshold value 602 of a consensus machine learning model, according to various embodiments. For example, such a consensus machine learning model may be used as a global starting model that is subsequently personalized to each of the three client devices. In the example shown, feature measurements 600 illustrate a balance between precision and recall as determined, at least in part, by classification threshold value 602, which is initially set at a particular global value but can subsequently be set differently (e.g., personalized) for different users. As explained below, by adjusting a classification threshold value for each particular user, a machine learning model can more accurately predict measurement outcomes, as compared to the case of using a single global classification threshold value for all users. A global classification threshold value can initially be set during training, which is based on a plurality of users. For example, an initial global classification threshold value may be set to a value determined by a priori training of a generic machine learning model upon which the machine learning model hosted by the client device is based. Such a classification threshold value of the generic machine learning model can be based, at least in part, on measured parameters of a population of users. Though such an initial value works well for a group of users, it may not work well for particular users.

In some implementations, a classification threshold value for each client device can be adjusted automatically (e.g., by the machine learning model being executed by each client device) for a particular user based, at least in part, on past and/or present behaviors of the particular user. In other implementations, a classification threshold value can be adjusted for each client device based, at least in part, on user input. In the latter implementations, for example, a user may desire to bias predictions by the machine learning model. In one example implementation, biasing can be performed explicitly by a user adjusting or inputting settings. In another example implementation, biasing can be performed implicitly based on user actions. Such biasing by the user can improve performance of the machine learning model.

Each arrow 604 represents a measurement or instance of a feature, such as a feature of a user or an action of the user. Each arrow is either in an up state or a down state. The arrows are placed from left to right based on measured mouth size of a user. For example, an arrow 606 toward the left end of the distribution represents small measured mouth size and an arrow 608 toward the right end of the distribution represents large measured mouth size. Measured mouth size (e.g., using a captured image) can be used to determine an emotional parameter of a user, e.g., whether the user is in a happy state or a not happy state. Arrow-down indicates mouth closed and arrow-up indicates mouth open in this example. Thus, in six measurements of mouth size, user A had their mouth closed two times and their mouth open four times. User B had their mouth closed four times and their mouth open two times. User C had their mouth closed three times and their mouth open three times.

As mentioned above, a machine learning model includes classifiers that make decisions based, at least in part, on comparing a value with a threshold value. In FIG. 6, mouths of users are classified as being closed if measurements of mouth size fall on the left of classification threshold value 602 and are classified as being open if measurements of mouth size fall on the right of classification threshold value 602. Thus, as can be seen in FIG. 6, if the machine learning model classifies users' mouths being open or closed based on classification threshold 602, then precision of results for the different users of the client devices will vary. For example, measurement arrow 610 indicates an open mouth of user A, but arrow 610 falls to the left of classification threshold 602 so the machine learning model of the client device for user A classifies the mouth of user A as being closed. In another example, measurement arrow 604 indicates a closed mouth of user B, but arrow 604 falls to the right of classification threshold 602 so the machine learning model of user B classifies the mouth of user B as being open. For user C, measurement arrows indicate an open mouth for each measurement on the right of classification threshold 602 and a closed mouth for each measurement on the left of classification threshold 602. Thus, in this particular case, the machine learning model of user C correctly classifies the mouth of user C in all cases.

As just demonstrated, a single threshold value applied to different users on client devices can yield different results. Classification threshold 602 happens to be set correctly for user C, but is set too high for user A and too low for user B. If classification threshold 602 is adjusted to precisely work for user A, then it will become less precise for users B and C. Thus, there is no single classification threshold value that can be precise for all users. Moreover, increasing a threshold value increases precision of the classification, though recall correspondingly decreases. For example, if a threshold value t for determining if a feature is in a particular state is set relatively high, then there will be relatively few determinations (e.g., recall) that the feature is in the particular state, but the fraction of the determinations being correct (e.g., precision) will be relatively high. On the other hand, decreasing the threshold value t decreases precision of the classification, though recall correspondingly increases.

As explained above, a single global classification threshold value applied to different users can yield different results. Personalization of machine learning models on each client device may involve applying particular classification threshold values t, to a number of users i that each have one type of use-profile or personal profile. Such personalization can provide relatively more accurate results compared to the case of applying the same global classification threshold value t to all users that each have different use-profiles or personal profiles, which can provide less accurate results. Accordingly, in some embodiments, a classification threshold value tᵢ for each user i can be set based, at least in part, on a particular user's profile or a profile of a class of users having one or more common characteristics. Moreover, a classification threshold value t can be modified or adjusted based, at least in part, on behaviors of the particular users. As explained above, a client device may modify a global classification threshold value t of a consensus machine learning model based, at least in part, on the information collected locally by the client device by performing an operation (e.g., minimization problem) defined by equation 2, introduced above.

In an example embodiment that illustrates a generic machine learning model and a feature of a user, a smiling classifier can be used to determine whether a user is smiling or not. This can be useful to determine whether the user is happy or sad, for example. To build a generic (e.g., global) machine learning model, measurements of mouth sizes can be collected for a population of users (e.g., 100, 500, or 1000 or more people). Measurements can be taken from captured images of the users as the users play a video game, watch a television program, or the like. The measurements can indicate how often the users smile. Measurements can be performed for each user every 60 seconds for 3 hours, for example. These measurements can be used as an initial training set for the generic machine learning model, which will include an initial (e.g., global) classification threshold value.

The initial classification threshold value will be used by a client device when the generic machine learning model is first loaded into the client device. Subsequent to this time, however, measurements will be made of a particular user of the client device. For example, measurements can be taken of mouth size of the user from captured images of the user as the user plays a video game, watches a television program, of the like. The measurements can indicate how often the user smiles. Measurements (e.g., from information collected on the client device) can continue, and the classification threshold value can be adjusted accordingly in a process of personalization, until the classification threshold value converges (e.g., becomes substantially constant). For example, checking consecutive threshold computations in the latest time frames allows for a determination of whether the average change between consecutive threshold values is below a particular predetermined small number (e.g., 0.00001). Thus, for example, the generic machine learning model may expect the user to be smiling 40% of the time. The user, however, may be observed to smile 25% of the time, as determined by collecting information about the user (e.g., measuring mouth size from captured images). Accordingly, the classification threshold value can be adjusted to account for the smiling rate observed for the user. The machine learning model may be personalized in this way, for example.

### Normalization of Aggregated Distributions

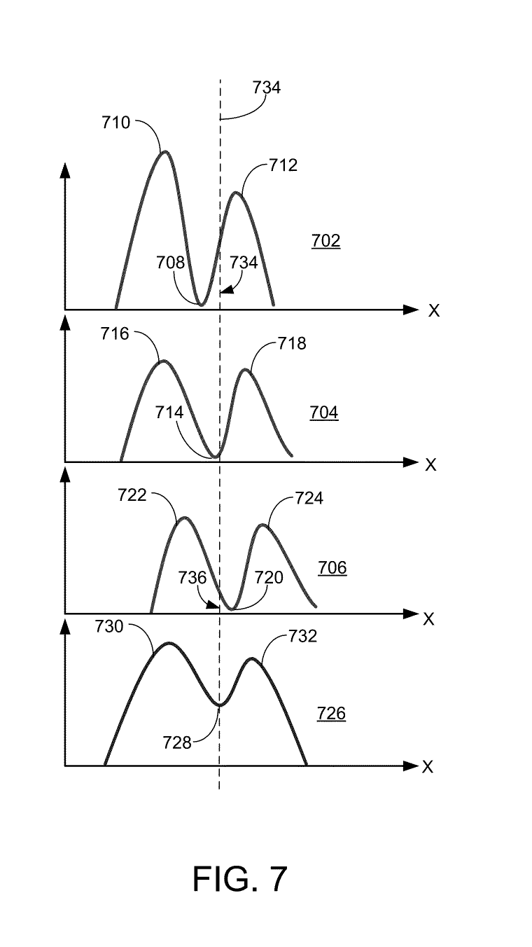

FIG. 7 shows three example distributions of a feature of three different users of client devices, and an aggregated distribution of the three example distributions, according to various example embodiments. Aggregating multiple feature distributions is a technique for de-identifying or “anonymizing” feature distributions of individual users, which can be considered personal data. Aggregating multiple feature distributions is also a technique for combining sampling data from multiple users of client devices on a server.

Feature distribution 702 represents a distribution of measurements of a particular parameter of a first user of a client device, feature distribution 704 represents a distribution of measurements of the particular parameter of a second user of a client device, and feature distribution 706 represents a distribution of measurements of the particular parameter of a third user of a client device. In some implementations the client device can be the same for two or more of the users. For example, two or more users may share a single client device. In other implementations, however, client devices are different for each user.

Parameters of users are measured a number of times on respective client devices to generate feature distributions 702-706. Such parameters can include a physical feature of a particular user, such as mouth size, eye size, voice volume, and so on. Measurements of parameters can be gleaned from information collected by each of the client devices operated by the users. Collecting such information can include capturing an image of users, capturing a voice sample of users, receiving a search query from users, and so on.

As an example, consider that the parameters of feature distributions 702-706 are mouth sizes of the three users. Measurements of mouth sizes can indicate whether a user is talking, smiling, laughing, or speaking, for example. The X-axes of feature distributions 702-706 represent increasing mouth size. Information from images of each user captured periodically or from time to time by the client devices of the users can be used to measure mouth sizes. Thus, for example, feature distribution 702 represents a distribution of mouth size measurements for the first user, feature distribution 704 represents a distribution of mouth size measurements for the second user, and feature distribution 706 represents a distribution of mouth size measurements for the third user. As can be expected, a particular physical feature of one user is generally different from the particular physical feature of another user. Maxima and minima (e.g., peaks and valleys) of a feature distribution (e.g., distribution of mouth sizes) can be used to indicate a number of things, such as various states of the feature of a user. For example, a local minimum 708 between two local maxima 710 and 712 in feature distribution 702 of the first user's mouth size can be used to define a classification boundary between the user's mouth being open or the user's mouth being closed. Thus, mouth size measurements to the left of local minimum 708 indicate the user's mouth being closed at the time of sampling (e.g., at the time of image capture). Conversely, mouth size measurements to the right of local minimum 708 indicate the user's mouth being open at the time of sampling.

For the second user, a local minimum 714 between two local maxima 716 and 718 in feature distribution 704 of the second user's mouth size can be used to define a classification boundary between the user's mouth being open or the user's mouth being closed. Similarly, for the third user, a local minimum 720 between two local maxima 722 and 724 in feature distribution 706 of the third user's mouth size can be used to define a classification boundary between the user's mouth being open or the user's mouth being closed. In general, feature distributions of values for different users will be different. In particular, positions and magnitudes of peaks and valleys, and thus positions of classification boundaries, of the feature distributions are different for different users. Accordingly, and undesirably, aggregating feature distributions on a server of a number of users leads to loss of resolution (e.g., blurring) of the feature distributions and concomitant loss of information regarding feature distributions of the individual users. For example, aggregated feature distribution 726 is a sum or superposition of feature distributions 702-706. A local minimum 728 between two local maxima 730 and 732 in aggregated feature distribution 726 can be used to define a classification boundary 734 between all of the users' mouths being open or the users' mouths being closed. Unfortunately, classification boundary 734 is defined with less certainty as compared to the cases for classification boundaries for the individual feature distributions 702-706. For example, certainty or confidence level of a classification boundary can be quantified in terms of relative magnitudes of the local minimum and the adjacent local maxima: The magnitude of local minimum 728 is relatively large compared to the magnitudes of local maxima 730 and 732 in aggregated feature distribution 726.

Accordingly, classification boundary 734 of the aggregated feature distribution can be relatively inaccurate in terms of the individual feature distributions 702-706. For example, the classification boundary corresponding to local minimum 708 of feature distribution 702 is offset from classification boundary 734 of the aggregated feature distribution, as indicated by arrow 734. As another example, the classification boundary corresponding to local minimum 736 of feature distribution 706 is offset from classification boundary 734 of the aggregated feature distribution, as indicated by arrow 736. Thus, using classification boundary 734 of the aggregated feature distribution for individual users can lead to errors or misclassifications. A process of updating a global machine learning model on the server can include normalization, which can alleviate such problems that arise from aggregating feature distributions of multiple users of client devices, as described below.

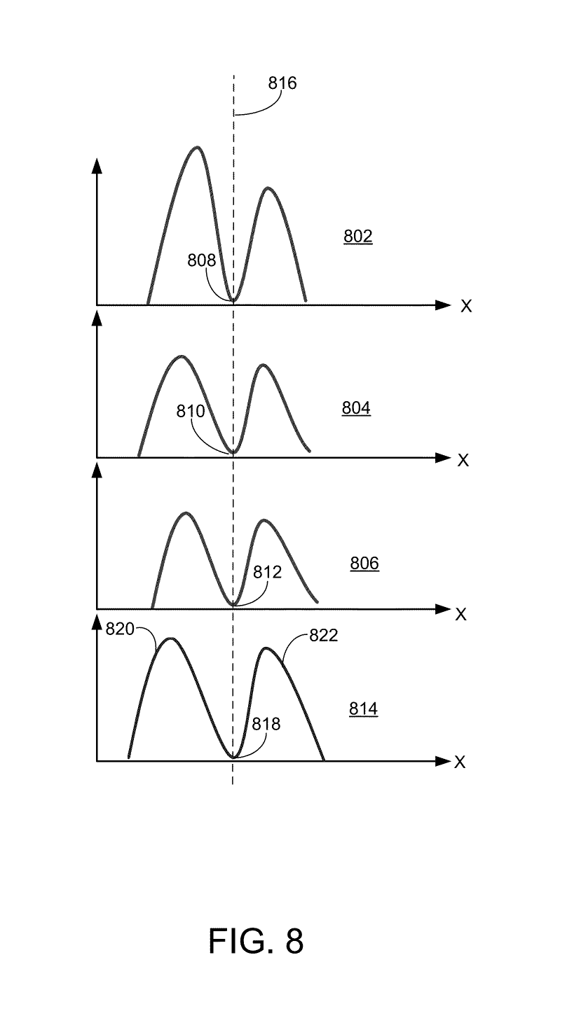

FIG. 8 shows normalized example distributions of a feature of three different users of client devices, and an aggregated distribution of the three normalized example feature distributions, according to various example embodiments. Such normalized feature distributions can be generated by a server that applies a normalization process to the feature distributions. For example, normalized feature distribution 802 results from normalizing feature distribution 702, shown in FIG. 7. Similarly, normalized feature distribution 804 results from normalizing feature distribution 704, and normalized feature distribution 806 results from normalizing feature distribution 706.

In one implementation, a normalization process applied to a feature distribution sets a local minimum to a particular predefined value. Extending this approach, applying such a normalization process to multiple feature distributions sets local minima to a particular predefined value. Thus, in the example feature distributions shown in FIG. 8, minima 808, 810, 812 of each of normalized feature distributions 802-806 are aligned with one another along the X-axes. In such a case, an aggregated distribution 814 of normalized feature distributions 802-806 also includes a local minimum 816 that aligns with minima 808-812 of normalized feature distributions 802-806. Because of such an alignment of local minima, classification boundaries of the normalized feature distributions 802-806 are the same as a classification boundary 816, defined by the X-position of local minimum 818, of aggregated feature distribution 814.

As mentioned above, feature distributions of values are generally different for different users of client devices. In particular, positions and magnitudes of peaks and valleys, and thus positions of classification boundaries, of the feature distributions are different for the different users. In such a case, aggregating feature distributions of a number of users undesirably leads to loss of resolution (e.g., blurring) of the feature distributions and concomitant loss of information regarding feature distributions of the individual users. A normalization process applied to the individual feature distributions, however, can lead to an aggregated feature distribution that maintains a classification boundary defined with greater certainty as compared to the case without a normalization process (e.g., aggregated feature distribution 726). For example, as mentioned above, certainty or confidence level of a classification boundary can be quantified in terms of relative magnitudes of the local minimum and the adjacent local maxima. The magnitude of local minimum 818 is relatively small compared to the magnitudes of local maxima 820 and 822 of aggregated feature distribution 814. Thus, aggregated feature distribution 814, based on normalized feature distributions 802-806, has a more distinct (e.g., deeper) local minimum than does aggregated feature distribution 726 (FIG. 7), which is based on un-normalized feature distributions 702-706. In other words, aggregated feature distribution 814, based on normalized feature distributions 802-806, provides a clear decision boundary (classification boundary) for determining a state of a feature of a user (e.g., user's mouth open or closed).

As mentioned, normalization described above may be performed by a server in a network (e.g., the Internet or the cloud). The server performs normalization and aligns feature distributions of data collected by multiple client devices. The server, for example, receives, from a first client device, a first feature distribution generated by a first machine learning model hosted by the first client device, and receives, from a second client device, a second feature distribution generated by a second machine learning model hosted by the second client device. The server subsequently normalizes the first feature distribution with respect to the second feature distribution so that classification boundaries for each of the first feature distribution and the second feature distribution align with one another. The server then provides to the first client device a normalized first feature distribution resulting from normalizing the first feature distribution with respect to the second feature distribution. The first feature distribution is based, at least in part, on information collected locally by the first client device. The method can further comprise normalizing the first feature distribution with respect to a training distribution so that the classification boundaries for each of the first feature distribution and the training distribution align with one another. Subsequent to aggregation and normalization, the server may modify a consensus (or global) machine learning model based, at least in part, on the aggregated and normalized personalized machine learning models transmitted to the server from the multiple client devices. The server can modify the consensus machine learning model by performing an operation (e.g., minimization problem) defined by equation 3.

The flows of operations illustrated in FIGS. 4 and 5 are illustrated as collections of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor(s) to perform the recited operations. In the context of hardware, the blocks may represent one or more circuits (e.g., FPGAs, application specific integrated circuits—ASICs, etc.) configured to execute the recited operations.

Any routine descriptions, elements, or blocks in the flows of operations illustrated in FIGS. 4 and 5 may represent modules, segments, or portions of code that include one or more executable instructions for implementing specific logical functions or elements in the routine.

### CONCLUSION

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain embodiments include, while other embodiments do not include, the noted features, elements and/or steps. Thus, unless otherwise stated, such conditional language is not intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described embodiments, the elements of which are to be understood as being among other acceptable examples. All such modifications and variations are intended to be included herein within the scope of this disclosure.

What is claimed is:

1. A method comprising:
hosting, by a client device, a consensus machine learning model;
collecting information, locally by the client device, associated with an application executed by the client device; and
modifying the consensus machine learning model accessible by the application based, at least in part, on the information collected locally by the client device, wherein modifying the consensus machine learning model generates a personalized machine learning model;
transmitting the personalized machine learning model to a server; and
receiving a global machine learning model from the server, wherein the global machine learning model is based, at least in part, on i) the personalized machine learning model transmitted to the server and ii) an aggregation of a plurality of other personalized machine learning models transmitted from a plurality of other client devices to the server.

2. The method of claim 1, wherein modifying the consensus machine learning model is further based, at least in part, on a hinge loss function including vectors representing (i) the information collected locally by the client device, (ii) target labels of the personalized machine learning model, (iii) the personalized machine learning model, and the transpose of the vector representing the personalized machine learning model.

3. The method of claim 2, wherein modifying the consensus machine learning model is further based, at least in part, on a comparison between the personalized machine learning model and the consensus machine learning model.

4. The method of claim 1, wherein transmitting the personalized machine learning model to the server comprises:
de-identifying at least a portion of the information collected locally by the client device.

5. The method of claim 1, wherein the information comprises private information of a user of the system.

6. The method of claim 1, wherein modifying the consensus machine learning model is further based, at least in part, on a pattern of behavior of a user of the client device over at least a predetermined time.

7. The method of claim 1, wherein collecting information comprises one or more of the following: capturing an image of a user of the client device, capturing a voice sample of the user of the client device, or receiving a search query from the user of the client device.

8. The method of claim 1, further comprising:
modifying the global machine learning model received from the server based, at least in part, on additional information collected locally by the client device, wherein modifying the global machine learning model generates an updated personalized machine learning model.

9. The method of claim 8, further comprising:
transmitting the updated personalized machine learning model to the server; and
receiving an updated global machine learning model from the server, wherein the updated global machine learning model is based, at least in part, on i) the updated personalized machine learning model transmitted to the server and ii) an aggregation of a plurality of other updated personalized machine learning models transmitted from at least a portion of the plurality of other client devices to the server.

10. A method comprising:
hosting, by a server, a global machine learning model;
receiving, from a plurality of client devices, personalized machine learning models, wherein the personalized machine learning models are based, at least in part, on information collected locally by each of the plurality of client devices;
modifying the global machine learning model based, at least in part, on the personalized machine learning models received from the plurality of client devices, wherein modifying the global machine learning model generates a modified global machine learning model; and
transmitting the modified global machine learning model to at least a portion of the plurality of client devices.

11. The method of claim 10, wherein modifying the global machine learning model is further based, at least in part, on a hinge loss function including vectors representing (i) an aggregation of the information collected locally by the plurality of client devices, (ii) target labels of the modified global machine learning model, (iii) the modified global machine learning model, and the transpose of the vector representing the modified global machine learning model.

12. The method of claim 11, wherein modifying the global machine learning model is further based, at least in part, on a minimization operation of a product of the global machine learning model and an estimate of a Lagrange multiplier.

13. The method of claim 10, wherein the personalized machine learning models received by the server include de-identified data representative of the information collected locally by the client devices.

14. The method of claim 13, wherein the de-identified data comprises private information of users of the client devices.

15. The method of claim 10, wherein modifying the global machine learning model and/or transmitting the modified global machine learning model is performed asynchronously with the plurality of the client devices.

16. The method of claim 10, wherein information collected locally by each of the plurality of client devices information comprises one or more of the following: a captured image of a user of the client device, a captured voice sample of the user of the client device, or a received search query from the user of the client device.

17. The method of claim 10, further comprising:
further modifying the global machine learning model based, at least in part, on additional information collected locally by at least a portion of the client devices, wherein further modifying the global machine learning model generates an updated global machine learning model; and
transmitting the updated global machine learning model to at least another portion of the plurality of the client devices.

18. Computer-readable storage media of a client device storing computer-executable instructions that, when executed by one or more processors of the client device, configure the one or more processors to perform operations comprising:
hosting, by the client device, a consensus machine learning model;
collecting information, locally by the client device, associated with an application executed by the client device; and
modifying the consensus machine learning model accessible by the application based, at least in part, on the information collected locally by the client device, wherein modifying the consensus machine learning model generates a personalized machine learning model;
transmitting the personalized machine learning model to a server; and
receiving a global machine learning model from the server, wherein the global machine learning model is based, at least in part, on i) the personalized machine learning model transmitted to the server and ii) an aggregation of a plurality of other personalized machine learning models transmitted from a plurality of other client devices to the server.

19. The computer-readable storage media of claim 18, wherein transmitting the personalized machine learning model to the server comprises:
de-identifying at least a portion of the information collected locally by the client device.

20. The computer-readable storage media of claim 18, wherein collecting information, locally by the client device, comprises monitoring one or more use patterns of a user of the client device.
